(19) United States
(12) Patent Application Publication
(10) Pub. No.: US 2012/0188569 A1
(43) Pub. Date: Jul. 26, 2012

(54) METHOD OF CREATING A PRINTABLE RASTER IMAGE FILE

(75) Inventors: Zhaorui YUAN, Venlo (NL); Paulus W.E. VERHELST, Venlo (NL); Maurice L.M. LUTTMER, Velden (NL)

(73) Assignee: OCE-TECHNOLOGIES B.V., Venlo (NL)

(21) Appl. No.: 13/416,172

(22) Filed: Mar. 9, 2012

Related U.S. Application Data
(63) Continuation of application No. PCT/EP2010/063447, filed on Sep. 14, 2010.

(30) Foreign Application Priority Data
Sep. 25, 2009 (EP) 09 171 367.7

(51) Int. Cl. H04N 1/60; G09G 5/02

(52) U.S. Cl. 358/1.9; 345/589

(57) ABSTRACT

A method of creating a printable raster image file from a PDL file, including interpreting the PDL file, thereby to create a display list; and applying raster image processing to the display list, thereby to create the printable raster image file in four separation colours (C, M, Y, K), wherein the raster image processing is performed in a Graphics Processing Unit (GPU) having three colour channels (R, G, B) and an alpha channel (A) for transparency, and the three colour channels and the alpha channel are mapped onto the four separation colours (C, M, Y, K).

The invention relates to a method of creating a printable raster image file from a PDL file, comprising the steps of:
interpreting the PDL file, thereby to create a display list; and
applying raster image processing to the display list, thereby to create the printable raster image file in four separation colours.

In the art of digital printing, the image to be printed is normally presented to the print engine, e. g. an ink jet printer or laser printer, in the form of an electronic raster image file. The raster image is divided into a plurality of rows and columns of pixels, and one or more values indicating the brightness or colour are assigned to each individual pixel. In black and white printing, the raster image may simply be a bitmap wherein the value assigned to an individual pixel has a size of only one bit indicating whether or not the pixel is to be printed in black. In colour printing, the image typical includes four colour separations, e. g. in the separation colours Cyan (C), Magenta (M), Yellow (Y) and Black (K), so that at least four bits are needed for each pixel. In case of a printer that is capable of printing dots of variable size or density, the raster image will comprise multi-level values for each pixel and colour.

Especially in case of large format, high resolution images, the raster images will comprise a large amount of data that is difficult to handle when the image is stored or transmitted in electronic data processing systems and networks.

This is why images or pages to be printed are frequently described in a Page Description Language (PDL) such as PostScript or PDF. In such a PDL, the image is composed of a plurality of relatively simple geometric objects such as lines or polygons, and what is stored in the PDL-file are only the coordinates of the vertices of these objects and the colour or colours with which they are to be filled. A process called Raster Image Processing (RIP) is used for transforming the PDL-file into a raster image file.

The raster image processing is typically done in a so-called front end of the printer which, to that end, is equipped with a raster image processor. Conventionally, the processor that is used as the raster image processor is a Central Processing Unit (CPU) of a multi-purpose computer or at least has the same architecture and is programmed in the same way as a CPU.

A modern personal computer or desktop computer, especially if it is used also for computer games, is typically equipped with a powerful graphics board or Graphics Processing Unit (GPU) which is used for rendering computer-generated graphics on the display screen of the computer. U.S. Pat. No. 6,860,203 B discloses a game console wherein such as GPU is used for rendering images on the display screen of the console. Further, this console is connectable to a digital printer so that images shown on the display may also be printed out. The GPU is used for creating not only the raster images to be displayed on the screen but also the raster images to be sent to the printer. Since the printer has a higher resolution than the display screen, a tiling procedure is applied for subdividing the image to be printed into a plurality of tiles that are small enough to be processed by the GPU, and these tiles are then “stitched” together to create a high-resolution raster image for the printer. However, since the GPU processes only the three colours Red (R), Green (G) and Blue (B) that are displayed on the monitor screen, the raster image rendered by the GPU must still be converted into the separation colours CMYK that are used in the printer. This conversion is done in the CPU of the game console and requires considerable time and processing power.

It is an object of the invention to provide a more efficient method for creating a printable raster image file from a PDL file. More specifically, the method shall be usable in high performance digital printers capable of printing with a high resolution of 600 dpi, for example, and capable of printing pages in the format A4, A3 or even more with a high throughput (e.g. 65 pages per minute or more).

In order to achieve this object, the method according to the invention is characterised in that raster image processing is performed in a Graphics Processing Unit (GPU) having three colour channels (R, G, B) and an alpha channel for transparency, wherein the three colour channels and the alpha channel are mapped onto the four separation colours (C, M, Y, K), with each separation colour being assigned to a different one of the three colour channels and the alpha channel.

The invention thus takes advantage of the fact that some commercially available GPUs have a fourth channel, the so-called alpha channel, in addition to the three colour channels RGB. Whereas GPUs are generally designed for processing only the three colours RGB that are displayed on a monitor screen, the alpha channel is used for specifying a certain amount of transparency of the image, if desired. Thus, by assigning suitable values to the alpha channel of each pixel, the image displayed on the screen may be caused to look more or less transparent. Since the alpha value is a quality of the pixel just as the three “normal” colour values, it is processed essentially in the same way as a colour, i.e. it participates in operations such as coordinate transformations, shadings and the like just as the colour values. The invention utilises this fact by simply re-interpreting the alpha value as a fourth colour value. Thus, the four separation colours that are needed by the printer are mapped onto the three colour channels and the alpha channel of the GPU which will then perform the major part of the raster image processing task and will eventually output a raster image with four output values per pixel, and these output values will be interpreted as the separation colours used in the printer.

The technology for GPUs that are used for raster image processing in accordance with the present invention has experienced a fast progress, driven mainly by the entertainment industry, so that commercially available GPUs are relatively cheap and nevertheless very powerful in processing large amounts of data as is necessary for raster image processing. In particular, GPUs have a highly parallel architecture, so that data for a large number of pixels can be processed in parallel, which greatly reduces the processing time. On the other hand, the available CPUs and the programming languages that have been developed specifically for these CPUs have enough flexibility to be suitably programmed for meeting the demands of efficient raster image processing in high performance digital printers. As a result, by utilising CPUs for raster image processing, the necessary processing time and the costs for hardware can be reduced significantly.

The invention also relates to a printer and a computer program product implementing the method according to the invention.

More specific optional features of the invention are indicated in the dependent claims.

Preferred embodiments will now be described in conjunction with the drawings, wherein:

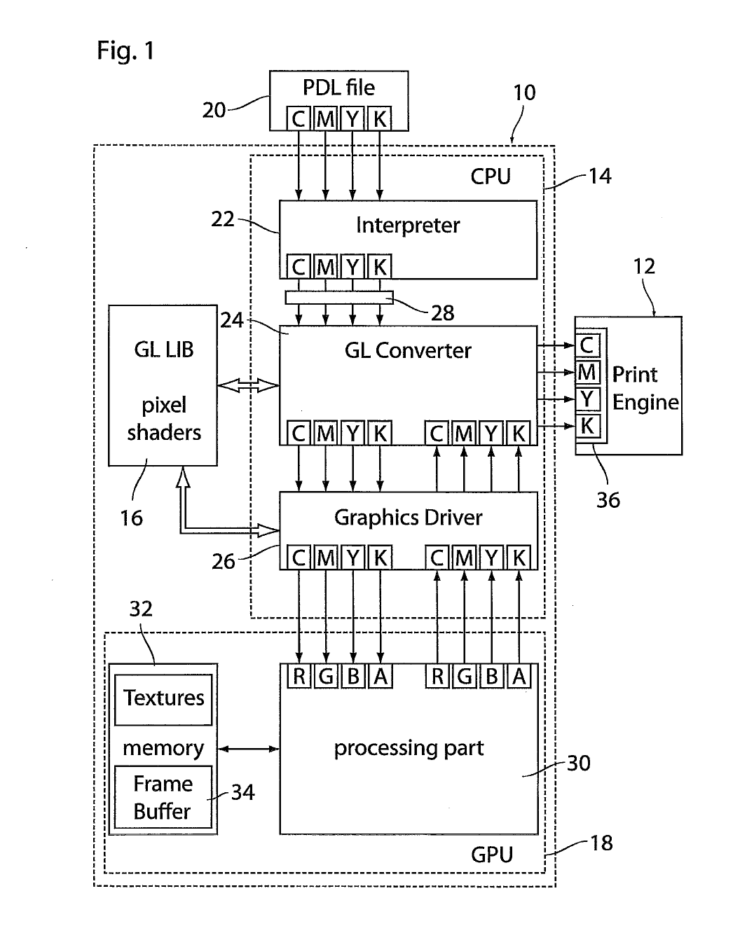

FIG. 1 is a block diagram of a printer adapted to perform the method according to the invention;

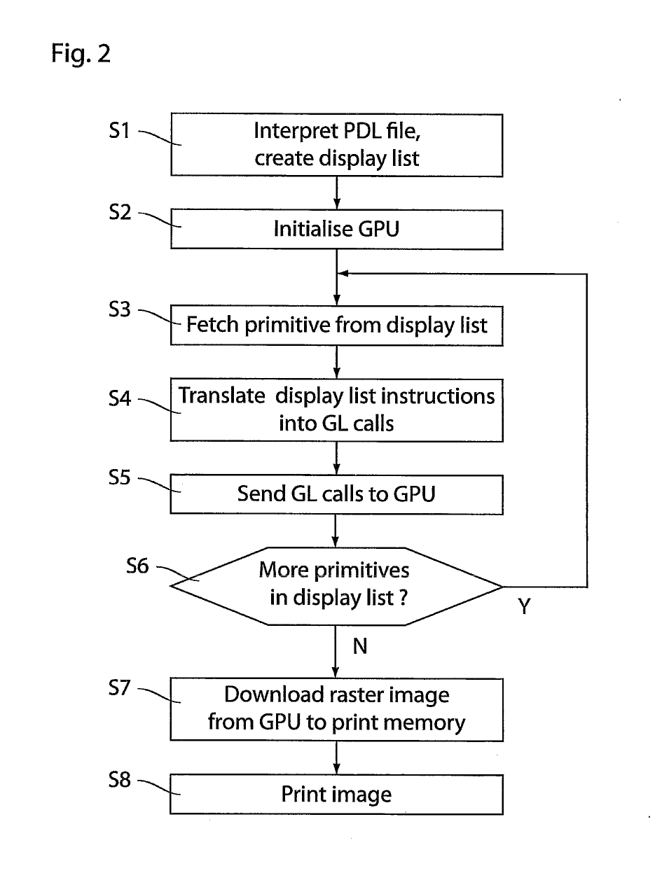

FIG. 2 is a flow diagram of a method according to a first embodiment of the invention;

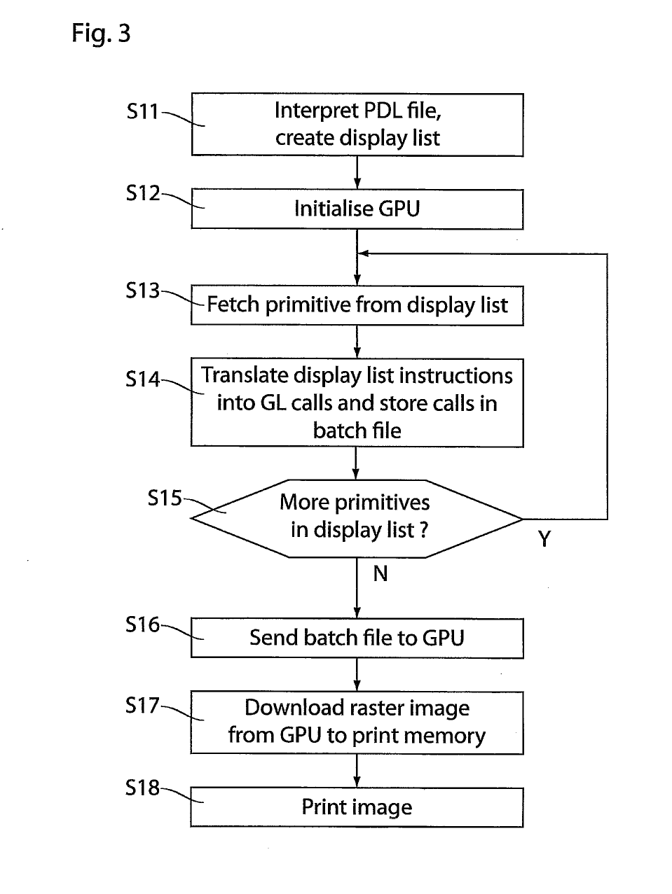

FIG. 3 is a flow diagram of a method according to a second embodiment of the invention; and

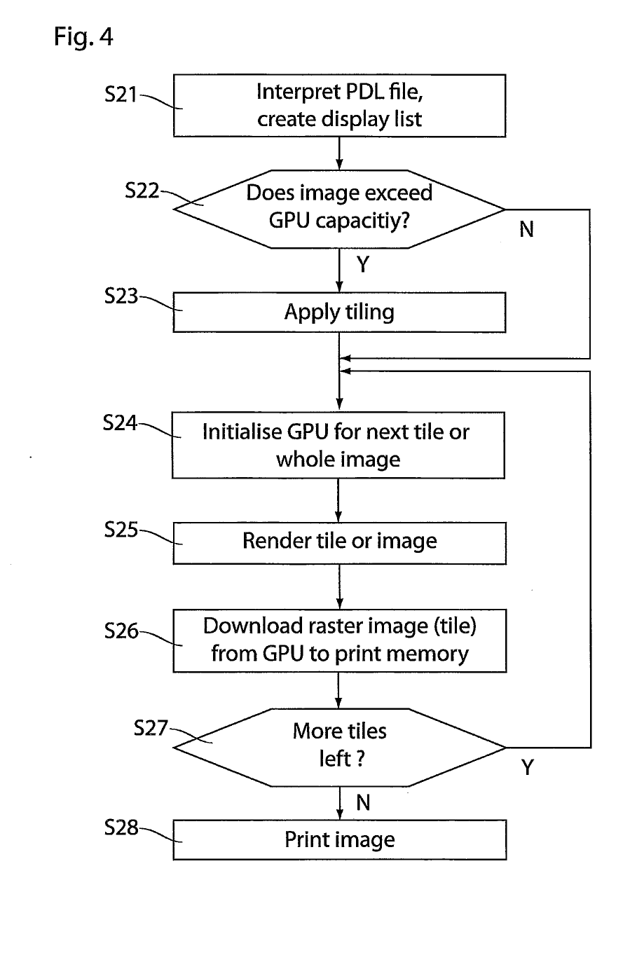

FIG. 4 is a flow diagram illustrating a further development of the method according to the invention.

The printer that has schematically been illustrated in FIG. 1 comprises a front end 10 and a print engine 12. The front end 10 has the task of transforming electronic print data that are supplied to the printer into a format suitable to be printed with the print engine 12. As is generally known in the art, the front end 10 comprises a CPU 14, memory space 16 for storing program code and data, as well as input and control means which have not been shown in FIG. 1.

In the shown embodiment, the front end 10 further comprises a Graphics Processing Unit (GPU) 18 of a type that is typically used in modern personal computers, game consoles or workstations for rendering images on a display screen. The GPU may be formed by a separate integrated circuit or may be integrated with the CPU 14 and other circuits and memory on the same substrate.

The data to be printed are typically received by the front end 10 in a format of a commonly used Program Description Language (PDL) such as PostScript or PDF. Thus, FIG. 1 shows a PDL file 20 that is received in and processed by the front end 10. By way of example, it is assumed that the image encoded in the PDL file is a colour image, and the colours are specified already in the CMYK colour space that is also used in the print engine 12. In general, the colours may be specified in the PDL file in some other colour space. If necessary, the front end 10 may perform a suitable colour management algorithm for adapting the colour space of the PDL file 20 to that of the print engine 12, as has been described for example in European Patent Application No. 08 154 135.1.

The functions of the CPU 14 have been represented in FIG. 1 by three modules: an interpreter 22, a GL converter 24 and a graphics driver 26.

On the basis of the information given in the PDL file 22, the interpreter 22 compiles a so-called display list 28. This display list is a list of primitives, i.e. instructions that define the location and appearance of graphical objects that compose the image to be printed. Among others, such primitives may include:
Fill a Trapezoid
The shape and location of the trapezoid is defined by the coordinates of its vertices (corners). Rectangles and triangles are included as special cases of trapezoids. When a source colour has been set, the entire area of the trapezoid is filled with that source colour. The trapezoids may be used to compose polygons of any shape. In a modified implementation, a primitive “Fill a Polygon” may be used.
Set a Source Colour
A colour in the CMYK colour space is defined as the source colour with which all subsequent trapezoids and run arrays will be filled until another source colour is set.
Set a Source Image
A source image is a raster image (colour values specified per pixel) associated with a transformation matrix. A trapezoid, for example, may be filled with a source image by subjecting the source image to a suitable coordinate transformation that clips the source image into outside the trapezoid.
Set an Image Mask
An image mask is defined by a bitmap and associated with a transformation matrix. Every pixel with the value “1” in the mask bitmap will be filled with the source colour, whereas pixels with the value “0” will be left unchanged.
Set a Bitmap Mask
Bitmap masks are similar to image masks but do not have a transformation matrix. They are used for example for rendering text.

When a mask primitive or a source primitive is set, it remains valid until another mask or source primitive is set or the display list finishes.

Dependent on their specified positions within the image, primitives like trapezoids may overlap. It may be specified as a general rule that primitives that are processed later overwrite all primitives that have been processed earlier. As an alternative, the vertices of the primitives may be given by three-dimensional coordinates, so that parts of a primitive may be hidden behind another primitive. In the embodiment presented here, the GPU 18 is capable of efficiently performing algorithms that identify and remove such hidden surfaces.

A primitive such as a trapezoid may also be arranged at the edge of the printable area so that parts of the primitive lie outside of the image to be printed. In that case, clipping algorithms are provided for clipping the primitive to the area of the image.

The GL converter 24 is a module that translates the instructions of the display list 28 into a Graphics Language (GL), i.e. a language that is used for programming the GPU 18. Several graphics languages, e.g. OpenGL, CUDA or DirectX, are available on the market. OpenGL is used in the present example.

The memory space 16 includes among others a graphics language library (GL library, an open GL library in the present case) to which the converter 24 has access, so that the converter may instruct the GPU 18 to call-up predefined functions and routines from the library. The memory space 16 further stores a specific type of programs which are called “pixel shaders” and instruct the GPU 18 to perform specific operations on individual pixels in order to change the colour and/or brightness thereof.

The GL converter 24 thus translates the primitives listed in the display list 28 into instructions—which are termed “GL calls”—for the GPU 18. The graphics driver 26 interfaces the CPU 14 to the GPU 18 and sends these GL calls to the GPU.

In the interpreter 22, the GL converter 24 and the graphics driver 26, the colours are always defined in the CMYK colour space. However, the GPU 18 is a device that has originally been designed for the specific purpose of driving a RGB monitor screen and is thus arranged to process only the three basic colours RGB.

The GPU 18 that is used in the present example has a fourth colour channel, the so-called alpha cannel (A), which is intended for specifying a certain transparency of a pixel. Correspondingly, the programming language for the CPU 18 (e.g. open GL) includes specific calls for making an image transparent. When such a call had been made and a pixel has to be superposed on a background, the A-value of the pixel would determine how the RGB values of the pixel are mixed with the background colours. The larger the A-value is, the more would the background “shine through” the overlaid image.

In the present embodiment, the three colour channels RGB and the alpha channel A of the GPU 18 are used for processing the four separation colours CMYK that are used in the CPU 10 and also in the print engine 12. For example, as has been shown symbolically in FIG. 1, the colour C is assigned to the R-channel of the GPU, the colour M is assigned to the G-channel, the colour Y is assigned to the B-channel and the colour K (black) is assigned to the alpha channel A. Of course, other assignments may also be possible. It is further observed that the GPU 18 may be configured to process colours either in the RGBA system or in a BGRA system in which the assignment of the RGB colours to the colour channels of the GPU is reversed.

The GPU 18 includes a processor part 30 and a memory part 32. In the example shown, the memory part 32 is organised as a fixed memory, i.e. memory spaces of a fixed size are reserved for the data to be stored. The data stored in these fixed memory spaces are called “textures”. These textures are comparable to arrays in ordinary CPU programming but have the specific feature that they have floating point indices, a feature that relates to the capability of the processor part 30 to perform very fast interpolation routines.

The textures may include three-dimensional (3D) textures (which are normally not used in the present printing application), 2D-textures for storing images, and 1D-textures. For example, the source images, image masks and bitmap masks mentioned above may be stored as 2D-textures, and a 1D-texture can be used for storing a colour conversion table that defines a source shade.

A specific memory space in the memory part 32 is called “frame buffer” and is used for storing a raster image file 34 that is to be created by the GPU. The processor part 30 of the GPU processes the GL calls and performs the operations necessary for placing the corresponding primitives at the right places in the frame buffer. To that end, the processor part 30 of the GPU 18 has a highly parallel processor architecture, so that many pixels may be processed in parallel.

When the entire image as specified by the display list 28 has been rendered and the corresponding raster image has been completed in the frame buffer, the graphics driver 26 will instruct the GPU 18 to download the contents of the frame buffer, i. e. the raster image file 34, either into a print memory 36 which may be either a system memory of the CPU 14 or a (buffer) memory of the print engine 12.

It will be noted that, since the transparency function is not used, the A-channel of the GPU 18 is treated as if it were a fourth colour of the pixel, and when the raster image file 34 is downloaded to the print engine 12 via the CPU 14, the CPU and the print engine will simply treat the A-value as the K-value of the pixel, while the R-, G- and B-values of the pixel are treated as the separation colours C, M and Y.

In the example shown, the frame buffer is included in the memory part 32 of the GPU 18. In a modified embodiment, an external memory may be used as the frame buffer. It is also possible to use an architecture in which the CPU 14 or the print engine 12 has direct memory access to the frame buffer so as to further accelerate the download procedure.

A method according to a first embodiment of the invention will now be explained in conjunction with the flow diagram shown in FIG. 2.

In step S1, the interpreter 22 of the CPU 14 interprets the PDL file 20 and creates the display list 28.

In step S2, the CPU performs a routine for initialising the GPU 18. This initialisation routine includes for example specifying the size of the frame buffer and erasing the former contents thereof, setting coordinate transformation matrices to unity, and the like.

Then, in step S3, the GL converter 24 will fetch the first primitive from the display list 28, and the instructions specifying this primitive are translated into GL calls in step S4.

In step S5, the GL call is sent to the GPU 18 which will then perform the necessary operations for placing the primitive at the right pixel positions in the frame buffer.

In step S6, the CPU checks whether there remain any more primitives in the display list that have not yet been processed. If this is the case (Y), then the routine loops back to step S3 to process the next primitive.

When all primitives in the display list 28 have been processed, the loop is exited with step S7, and the raster image file 34 is downloaded from the GPU 18 (or the external frame buffer) to the print memory. The raster image may then be stored in the print memory for future use or may directly be printed out with the print engine 12 in a final step S8.

FIG. 3 is a flow diagram of a modified embodiment. The steps S11-S13 identical with the steps S1-S3 shown in FIG. 2.

Step S14 corresponds to step S4 in FIG. 2, with the difference that, in step S14, the GL calls are stored in a batch file in the memory space 16 of the CPU 14.

Step S15 in FIG. 3 corresponds to the step S6 in FIG. 2 which decides whether all primitives have been processed.

In FIG. 3, the loop of steps S13, S14 and S15 is exited via a step S16 in which the batch file including the GL calls for all the primitives is sent to the GPU 18.

Steps S17 and S18 in FIG. 3 are again identical with the steps S7 and S8 in FIG. 2.

In CPUs that are commercially available today, the processing and storage capacity is sufficient for processing a raster image with a size corresponding to A4 and a resolution of 600 dpi. FIG. 4 illustrates a method that may be applied when the image to be printed and, accordingly, the raster image, is of a larger size (A3 or more) and has a resolution of 600 dpi, so that the capacity of the GPU 18 would be exceeded.

Step S21 corresponds to steps S1 and S11 of the previous embodiments.

In step S22, the GPU 14 decides whether or not the image, the size of which is indicated in the PDL file and the display list, respectively, exceeds the capacity of the GPU 18.

If that is the case, a step S23 is performed, wherein a tiling procedure is applied to the image that is specified by the PDL file. In this tiling procedure, the image is divided into a plurality of sub-images or tiles that are abuttingly placed side by side in rows and/or columns, so that, together, they cover the entire image, whereas the individual tile has the size small enough to be processed in the GPU. If the original image can directly be processed by the GPU (N in step S22), then the step S23 is skipped.

Then, in step S24, the GPU 18 is initialised either for the first tile (when step S23 has been performed) or for the whole image (when step S23 has been skipped).

In step S25, the tile or image is rendered in the same way as in steps S3 to S6 in FIG. 2 or steps S13 to S16 in FIG. 3.

In step S26, the raster image which has the size of only a single tile is downloaded to the print memory 36.

Step S27 checks whether there are more tiles (provided that the step S23 has been performed) that have not yet been processed. If this is the case, the program loops back to step S24 to initialise the GPU 18 for the next tile. When this tile has been rendered in step S25 and is downloaded to the print memory 36 in step S26, the print memory is addressed such that the raster image of the first tile and the current tile are seamlessly “stitched together” in the print memory. If there are more tiles left, they are processed in the same way by looping through the steps S24-S27.

When all tiles have been rastered, the loop is exited with step S28, and the image is printed from the print memory 36.

1-4. (canceled)

5. A method of creating a printable raster image file from a PDL file, comprising the steps of:
interpreting the PDL file, thereby to create a display list;
applying raster image processing to the display list, thereby to create the printable raster image file in four separation colours (C, M, Y, K); and performing the raster image processing in a Graphics Processing Unit (GPU) having three colour channels (R, G, B) and an alpha channel (A) for transparency,
wherein the three colour channels and the alpha channel are used for processing the four separation colours (C, M, Y, K), with each separation colour being assigned to a different one of the three colour channels and the alpha channel.

6. The method according to claim 5, wherein a CPU is used for translating the PDL file into instructions in a graphics language (GL), said instructions being executed by the GPU.

7. A digital printer comprising a front end and a print engine, wherein the front end is adapted to carry out the method according to claim 5.

8. A computer program product embodied on a non-transitory computer readable medium, and including program code that, when run on a data processing system having a CPU and a GPU, causes the CPU and the GPU to carry out the method according to claim 5.

9. A digital printer comprising a front end and a print engine, wherein the front end is adapted to carry out the method according to claim 6.

10. A computer program product embodied on a non-transitory computer readable medium, and including program code that, when run on a data processing system having a CPU and a GPU, causes the CPU and the GPU to carry out the method according to claim 6.
